(19) United States
(12) Patent Application Publication
(10) Pub. No.: US 2012/0050001 A1
(43) Pub. Date: Mar. 1, 2012

(54) SECURITY SYSTEM WITH CONTROL DEVICE

(75) Inventor: Richard Koether, Langerwehe (DE)

(73) Assignee: ROBERT BOSCH GMBH, Stuttgart (DE)

(21) Appl. No.: 13/203,647

(22) PCT Filed: Feb. 19, 2010
(86) PCT No.: PCT/EP10/52150

§ 371 Date: Nov. 4, 2011

(30) Foreign Application Priority Data
Feb. 26, 2009 (DE) 10 2009 001 177.3

(51) Int. Cl. G05B 19/02

(52) U.S. Cl. 340/4.3

(57) ABSTRACT

Access control systems, for example in buildings, have the task of checking the authorization of persons wanting to enter or leave the building or partial areas thereof. The invention relates to a security system (1) for monitoring and/or controlling partial areas in a surveillance area, comprising at least one control device (2) which is designed for the input and/or output of information and/or signals in one of the partial areas, a communication network (3) for establishing communication to the at least one control device (2), wherein the control device (2) has a first Ethernet connection (4) for communicating with the communication network (3) and the control device (2) has a second Ethernet connection (4) for communicating with the communication network (3).

### BACKGROUND OF THE INVENTION

The invention relates to a security system for monitoring and/or controlling subsections in a monitoring area having at least one control device which is designed for the input and/or output of information and/or signals in one of the subsections, and having a communication network which is designed for the communication connection of the at least one control device, wherein the control device has a first Ethernet port for the communication with the communication network.

Entry control systems, for example in buildings, have the task of checking the authorization of a person who wishes to enter or leave the building or subsections thereof. While many installations involve only one entrance control, it is customary, particularly in the case of security-relevant areas, to define areas with different entry authorizations. It is also possible for buildings on a site to be provided with different entry authorizations. While a simple entrance control may have the entry control system positioned locally at the entrance, an entry control system having a plurality of subsections and having different authorizations requires distributed verification devices to be positioned in a decentralized manner. In order to be able to control said verification devices centrally, they are connected via a data network which can be used to initialize or update authorizations and to transmit verifications which have been performed.

By way of example, laid-open specification DE 100 012 53 A1 discloses an apparatus for the input and/or output of information, which apparatus is used for one of the following fields of application: time management, entry control, security engineering or building services. The apparatus is in the form of an installable unit and has a communication module which sets up the connection to a communication network. The communication takes place via an RS485 network or an LSN (local security network), for example.

### SUMMARY OF THE INVENTION

The invention proposes a security system for monitoring and/or controlling subsections in a monitoring area.

The security system is preferably suitable and/or designed for implementing time management, entry control, security engineering and/or building services. The monitoring area may be in the form of a building, a plurality of buildings or a building complex, a space and/or another local environment. The subsections are preferably in the form of lock sections, which are embodied as turnstiles, doors, singularization devices or the like, for example.

The security system has at least one control device, preferably a plurality of such control devices, which is/are designed for the input and/or output of information and/or signals in one of the subsections. By way of example, the information may be authorization information which is transmitted to the control device for the purpose of verification and/or authorization checking. In particular, the information may be authorization information, such as the information on an authorization card, badge, etc. that has been read, an input authorization information item, such as a code, and/or a captured authorization information item, such as biometric data, for example. By way of example, the signals may be in the form of status signals and may relate particularly to the status of the lock (e.g. open/closed/impaired) and/or the activity of the lock (e.g. active/passive). With particular preference, the signals comprise control signals for opening and closing the lock.

The security system comprises a communication network which is designed for the communication connection of the at least one control device, particularly by means of the interchange of communication signals, so that the control device can interchange the information and/or the signals or other data via the communication network. The communication signals are preferably in the form of Ethernet data transmission blocks and/or in the form of digital signals.

The control device has a first Ethernet port for the communication with the communication network. The Ethernet port is preferably implemented as a 10 Mbit/s, 100 Mbit/s, 1 gigabit/s or 10 gigabit/s Ethernet port, particularly as a fast Ethernet port. Preferably, the Ethernet port is defined by means of the IEEE 802.3 standard.

The invention proposes that the control device has at least one second Ethernet port for the communication with the communication network. The second Ethernet port is preferably implemented under the same standard as the first Ethernet port and/or using the same design and/or the same functions.

One possible advantage of the invention is that the doubled Ethernet port can be used for redundant connection of the control device to the communication network. In particular, both the first and the second Ethernet port can be operated independently of the operational status of the respective other Ethernet port. The effect of the modification according to the invention is that the control device remains ready for operation even if a supply line to one of the two Ethernet ports is interrupted or impaired. In this context, it can be regarded as particularly advantageous that both network ports may be based on the same standard, which means that only the characteristics of a single standard, for example in respect of free cable length, shielding, etc., need to be considered during planning, assembly and startup.

In the most general embodiment, it is conceivable for the control device to be supplied locally with a supply voltage, e.g. via a dedicated power supply unit or a supply line. In one particularly preferred development of the invention, however, the first and/or the second Ethernet port is designed such that besides the communication signals a supply voltage for supplying the control device can be transmitted. In many embodiments, this type of transmission of the supply voltage can also be referred to as PoE (Power over Ethernet). The advantage of this addition is that the control device needs to have neither an autonomous supply voltage nor additional cables for providing a supply voltage.

In one particularly preferred development of the invention, a preferably analog supplementary signal can be transmitted in the first and/or in the second Ethernet port besides the communication signals of the Ethernet. Similarly to in the case of the supply voltage, this also exhibits the advantage that an additional signal can be transmitted without additional cabling complexity.

With particular preference, the supplementary signal is in the form of an alarm signal, particularly in the form of a fire alarm signal. For security reasons, many countries do not permit alarm signals, particularly fire alarm signals, to be transmitted by software in the normal communication data stream. Instead, it is prescribed for the alarm signal to be transmitted as a separate, preferably analog, signal. The fact that the first and/or second Ethernet port is/are designed for transmitting the supplementary signal means that the already available cables of the Ethernet can also be used for transmitting the supplementary signals.

With particular preference, the control device is connected to the communication network via the Ethernet ports by means of multicore, in particular eight-core, network cables. These network cables preferably have four twisted-pair cables with a total of eight cores, only four or six cores being used for the transmission of the Ethernet communication. The remaining four or two cores can, by contrast, be used for transmitting the supply voltage and/or the alarm signal. This means that commercially available, cheap and high-quality network cables can be used for the cabling of the communication device and it is nevertheless possible to transmit the supply voltage and the supplementary signal at the same time.

With particular preference, the Ethernet ports have sockets which are designed for eight-terminal (8P8C) modular connectors, particularly “RJ-45”. The modular connectors may be in unshielded, but preferably shielded, form.

In one possible development of the invention, provision is made for the control device to be designed to transmit the supplementary signal and/or the supply voltage in cores of the network cables which are used for the Ethernet communication. This modification has the possible advantage that both the supply voltage and the supplementary signal can be transmitted in a single network cable. Preferably, both network cables connected to the two Ethernet ports have this functionality. In this manner, a completely redundant system is formed, with the Ethernet communication, the supply voltage and the supplementary signal being transmitted redundantly.

The topology of the communication network may optionally have provision for two different network areas to be formed which work independently of one another, with the respective network area being associated with one of the Ethernet ports. In this embodiment, not only are the network cables made in redundant or semiredundant form, but also entire network areas are implemented in duplicate or redundant form in order to ensure that the security system functions even if a network area fails.

In particular, the communication network has a first master controller and a second, redundant master controller, the master controller and/or the second, redundant master controller both being designed for the communication with the control device. From the point of view of the network architecture, the master controller and the redundant master controller may be arranged in a common network area or else in two mutually independent network areas.

In one advantageous development of the invention, the control device is in the form of a lock and/or door control device which performs authorization control for these entry areas.

In one possible implementation of the invention, the control device comprises an operation control element for the input of a signal for opening the lock or the door, particularly a touch sensor and/or identification mark reader and/or interfaces for signal-related interconnection to the or a further operator control element or identification mark reader.

### BRIEF DESCRIPTION OF THE DRAWINGS

Further features, advantages and effects of the invention can be found in the description below of preferred exemplary embodiments of the invention and in the appended figures, in which:

FIG. 1 shows a schematic block diagram of a detail from a security system as a first exemplary embodiment of the invention;

FIG. 2 shows a schematic detail enlargement in FIG. 1;

FIG. 3 shows a schematic block diagram of a first possible architecture of a security system as a second exemplary embodiment of the invention;

FIG. 4 shows a further architecture of a security system as a third exemplary embodiment of the invention;

FIG. 5 shows a schematic illustration of a control device in the security system;

FIG. 6 shows a schematic illustration of a further component in the security system from the preceding figures.

### DETAILED DESCRIPTION

FIG. 1 shows a highly schematic illustration of a security system 1 which is in the form of a door control system, for example. The security system 1 comprises a plurality of control devices 2 which are designed for the control of doors or locks in order to open and close said doors or locks. The control devices 2 are connected for the purpose of data interchange via a communication network 3, so that the communication network 3 can be used to interchange data with the control devices 2.

The control devices 2 are in the form of local devices which are arranged in proximity to the door or lock that is to be controlled. For the purpose of communication with the communication network 3, the control device 2 has two separate Ethernet ports 4 which are connected to the communication network 3 via Ethernet cables 5. The control device 2 is designed such that the Ethernet cables 5 are used redundantly, so that in the event of damage or impairment to one of the two Ethernet cables 5, communication between a control device 2 and a communication network 3 is maintained.

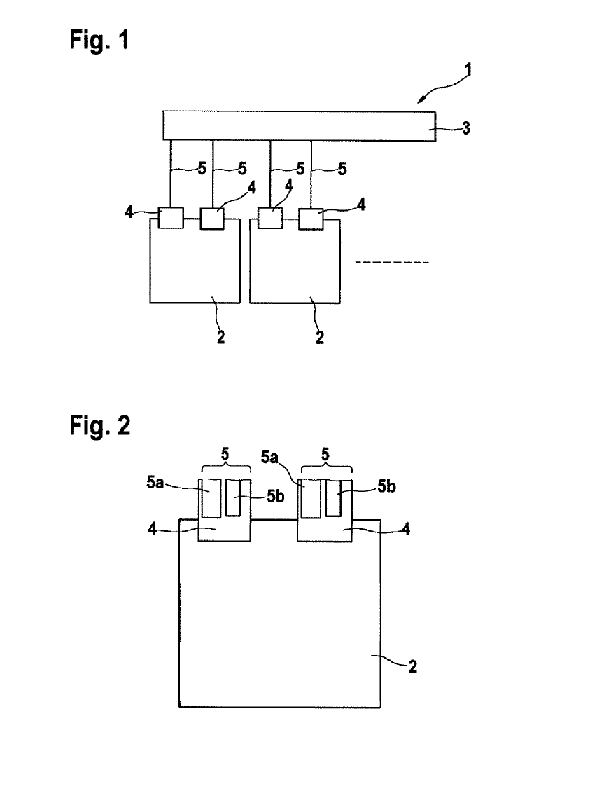

FIG. 2 shows a detail illustration of the control device 2 in FIG. 1, likewise in a schematic illustration. Each of the Ethernet ports 4 is connected to an Ethernet cable 5 which has eight cores, with two respective cores being twisted together, for example. The socket of the Ethernet port 4 is in the form of a J45 port, for example. The communication with the communication network 3 takes place digitally, in line with the Ethernet standard, via four respective cores 5a of the Ethernet cable 5. The remaining four cables 5b can be used for the transmission of supply voltage and/or supplementary signals. The transmission of supply voltage via the four free cables 5b is also known as Power over Ethernet (PoE). Alternatively or in addition, it is also possible for analog signals and/or supplementary signals to be transmitted via the four cores 5a which are used for the network communication. This gives the following options for each Ethernet port 4:

A: Network communication and supply voltage

B: Network communication and supplementary signal

C: Network communication and supplementary signal and supply voltage

Depending on the desired configuration, the two Ethernet ports 4 may be of completely redundant design by virtue of the them both being designed on the basis of option A or B or else C. In case B, the supply voltage would be provided by means of an autonomous supply voltage for the control device 2, for example. Alternatively, hybrid operation is also possible, with, for example, the first Ethernet port 4 being operated on the basis of option A and the second Ethernet port 4 being operated on the basis of option B. In principle, it is also possible for further Ethernet ports 4 to be integrated into the control device 2.

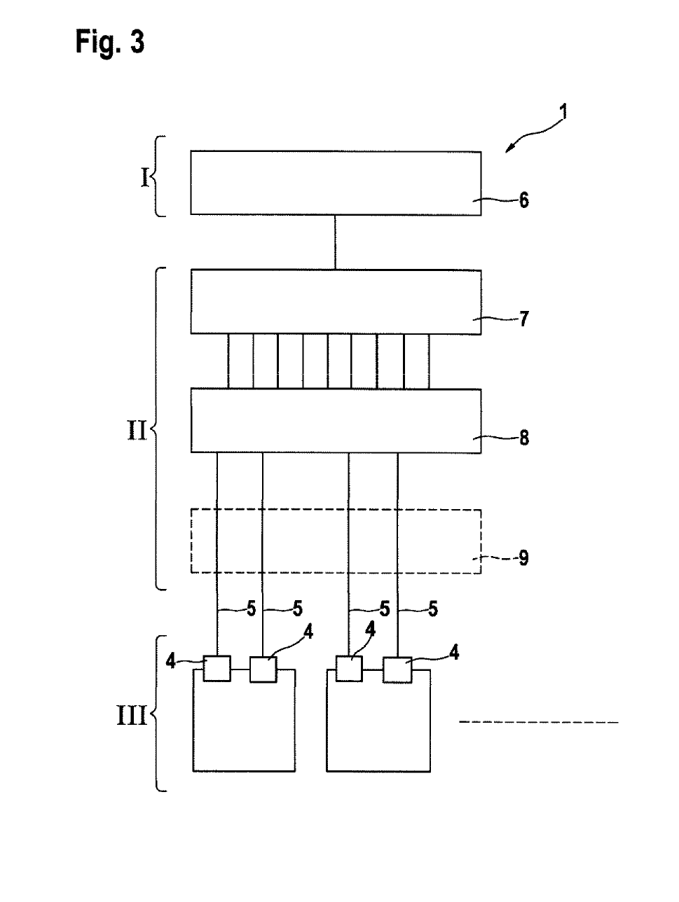

FIG. 3 shows a first architecture of a security system 1 in a schematic block diagram as a further exemplary embodiment of the invention. The security system 1 can be divided into three levels or layers, with a first layer I comprising a data management server 6 (DMS) which, by way of example, is in the form of a personal computer with a Windows server operating system and a database management system, such as Oracle, MSSQL or MySQL. The server 6 manages all the information for the security system 1. By way of example, workstations—not shown—can be used to input authorizations and information from identification marks, said authorizations and information being requested and checked using the control devices 2.

In a second layer II, one or more main entry control devices 7 (Main Access Controller) are implemented which communicate with the control devices 2 and receive information about the position of persons in the monitoring area, for example. The main entry control devices may be designed to supply 64 control devices 2 with communication signals, for example.

Such a security system 1 may contain a plurality of main entry control devices 7, with one such main entry control device 7 being provided for each building to be monitored or for each more complex area to be monitored, for example. In addition, the layer II may contain a signal supply device 8 which feeds the supply voltage and/or the supplementary signal into the Ethernet cables 5. Optionally, the signal supply device 8 or the layer II generally has an uninterruptable power supply 9 for safeguarding the supply voltage.

A third layer III accommodates the control devices 2, which comprise a plurality of inputs and outputs for the monitoring and control of the doors and possibly devices for reading identification marks, such as identification cards. In the case of the architecture shown in FIG. 3, only the Ethernet cables 5 and the Ethernet ports 4 are of redundant design.

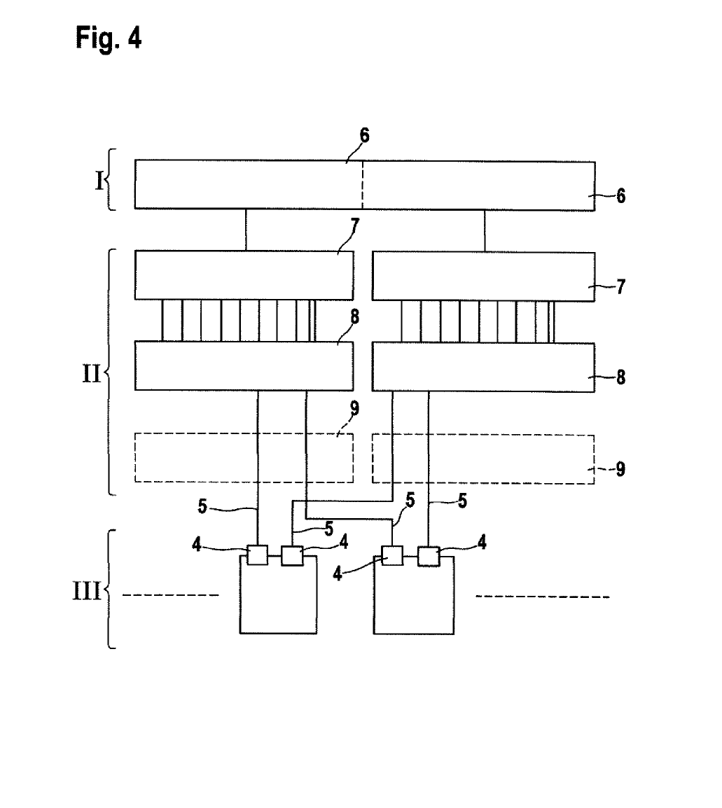

By contrast, FIG. 4 shows an architecture which is of similar design to that in FIG. 3, but in which two main entry control devices 7 are provided for each building or each logical area. Optionally, it is also possible for separate signal supply devices 8 and uninterruptable power devices 9 to be provided. In this architecture, each control device 2 is supplied with communication signals and possibly supplementary signals and supply voltage by at least two main entry control devices 7. In this architecture, operation can even be maintained if a main entry control device 7 fails, since the entire communication can take place redundantly via the other main entry control device 7.

In a further architecture, which is indicated in FIG. 4 by a dashed line, two separate servers 6 operating independently of one another are also provided, so that even if a server fails it is possible for a redundant server 6 to supply the control devices 2 with communication signals via the main entry control device 7.

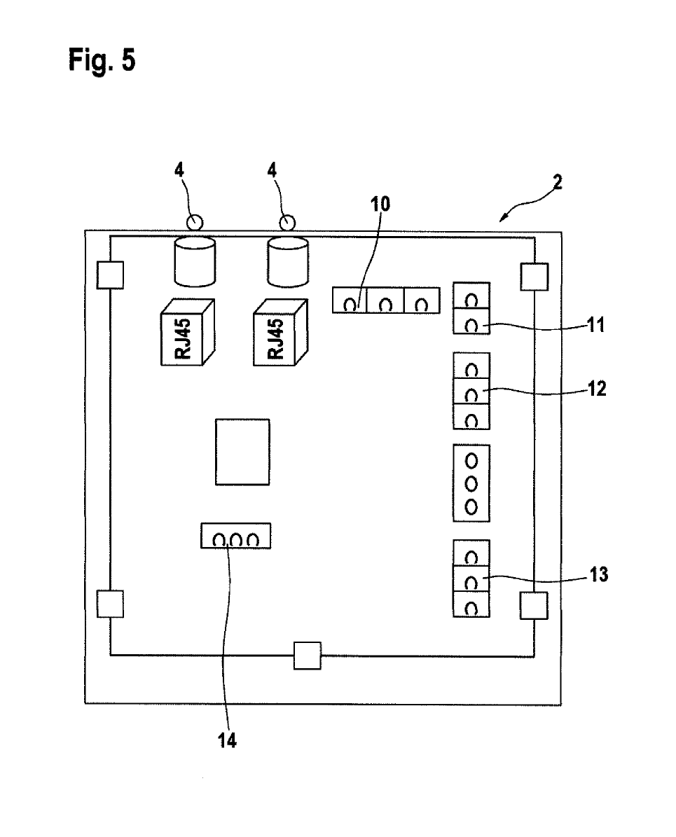

FIG. 5 shows a highly schematic illustration of the design of a control device 2 from the preceding figures. The control device 2 has the two mutually isolated Ethernet ports 4, and also optionally, additionally, ports for a supply voltage 10, an input 11 for recognizing the status of the door or lock (open/closed), an input 12 for an external operator control button, and also output channels 13 for actuating the door or lock. By way of example, the operator control button is in the form of an REX (Request to Exit) unit. As an optional addition, a service port 14 based on the R232 standard is provided.

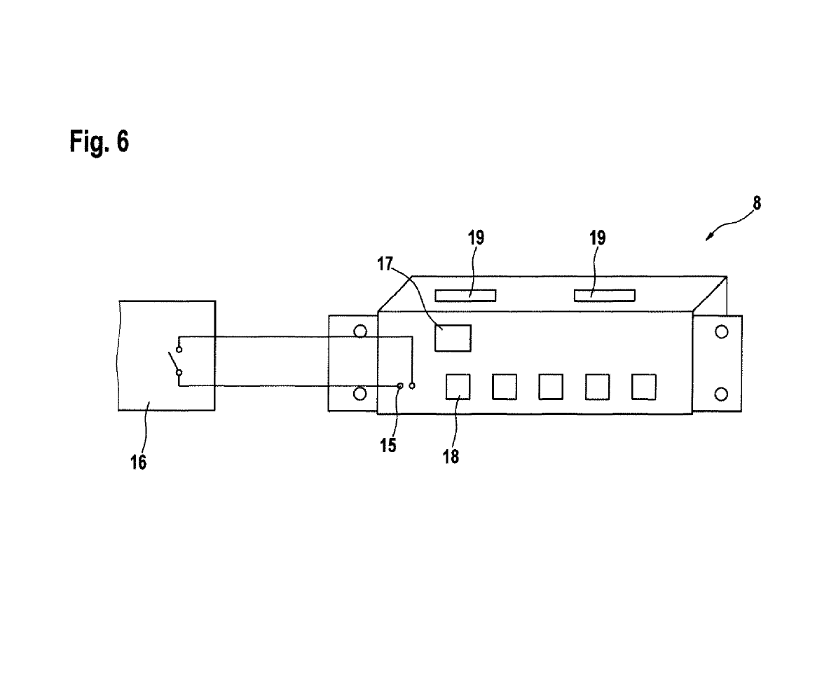

FIG. 6 shows an optional addition to the security system 1, with one possible embodiment of the signal supply device 8 being able to be used to route a fire alarm signal via the Ethernet cables 5 to the control device 2. As a possible reaction to a fire alarm signal which is present, the control device 2 releases and/or opens the controlled doors. To this end, the signal supply device 8 has an alarm signal input 15 which can be used to apply a fire alarm signal, e.g. from a manual call point 16. In addition, the signal supply device 8 comprises at least one Ethernet input 17, which is connected to the server 6, and a plurality of Ethernet outputs 18, which are connected to the Ethernet ports 4 of the control devices 2. Optionally, the signal supply device 8 is equipped with an uninterruptable voltage supply 19 or with batteries or storage batteries in order to convert the applied fire alarm signal into an analog, electrical signal, or to amplify said fire alarm signal. Alternatively, the signal supply device 8 is equipped with another voltage supply. The analog signal formed from the fire alarm signal is fed into the Ethernet lines 5, as has been described previously, with the entire signal path between the generator of the alarm signal and the control device 2 being of analog design. In other embodiments, the fire alarm signal is fed into the Ethernet lines 5 via a passive component.

Through the use of two Ethernet ports 4 per control device 2, preferably each with PoE capability, the invention permits inexpensive implementation of a security system 1 which can be designed with complete redundancy, which meets the requirements of security applications and which can optionally transmit a fire alarm signal in accordance with the regulations.

1. A security system (1) for monitoring and/or controlling subsections in a monitoring area having at least one control device (2) which is designed for the input and/or output of information and/or signals in one of the subsections, having a communication network (3) which is designed for a communication connection of the at least one control device (2), wherein the control device (2) has a first Ethernet port (4) for communication with the communication network (3), characterized in that
the control device (2) has a second Ethernet port (4) for communication with the communication network (3).

2. The security system (1) as claimed in claim 1, characterized in that the second Ethernet port (4) is a redundant communication connection.

3. The security system (1) as claimed in claim 1, characterized in that the control device (2) is designed so that a supply voltage can be transmitted in the first and in the second Ethernet port (4).

4. The security system (1) as claimed in claim 1, characterized in that an analog supplementary signal can be transmitted in the first and in the second Ethernet port (4).

5. The security system (1) as claimed in claim 4, characterized in that the analog signal is in the form of an alarm signal.

6. The security system (1) as claimed in claim 1, characterized in that the control device (2) is connected via the Ethernet ports (4) to eight-core network cables (5).

7. The security system (1) as claimed in claim 4, characterized in that the control device (2) is designed to transmit the analog signal.

8. The security system (1) as claimed in claim 1, characterized in that the communication network (3) has two different network areas, wherein each network area is associated with one of the Ethernet ports (4).

9. The security system (1) as claimed in claim 1, characterized in that the communication network (3) has a redundant master controller.

10. The security system (1) as claimed in claim 1, characterized in that the control device (2) is in the form of a lock and/or door control device.

11. The security system (1) as claimed in claim 1, characterized in that the control device (2) has a lighting element, a touch sensor and/or an identification mark reader.

12. The security system (1) as claimed in claim 1, characterized in that the control device (2) is designed so that a supply voltage can be transmitted in the first Ethernet port (4).

13. The security system (1) as claimed in claim 1, characterized in that the control device (2) is designed so that a supply voltage can be transmitted in the second Ethernet port (4).

14. The security system (1) as claimed in claim 1, characterized in that an analog supplementary signal can be transmitted in the first Ethernet port (4).

15. The security system (1) as claimed in claim 1, characterized in that an analog supplementary signal can be transmitted in the second Ethernet port (4).

16. The security system (1) as claimed in claim 4, characterized in that the analog signal is in the form of a fire alarm signal.

17. The security system (1) as claimed in claim 3, characterized in that the control device (2) is designed to transmit the supply voltage in cores which are unused in the communication connection to the communication network (3).

18. The security system (1) as claimed in claim 1, characterized in that the control device (2) is designed so that a supply voltage can be transmitted in at least one of the first and the second Ethernet ports (4) in cores which are unused in the communication connection to the communication network (3), and in that an analog supplementary signal can be transmitted in at least one of the first and the second Ethernet ports (4) in cores which are unused in the communication connection to the communication network (3).
